(19) United States
(12) Patent Application Publication
(10) Pub. No.: US 2020/0395630 A1
(43) Pub. Date: Dec. 17, 2020

(54) PROTECTIVE SACRIFICIAL COATING TO ENHANCE STABILITY OF BATTERY MATERIALS

(71) Applicant: GM GLOBAL TECHNOLOGY OPERATIONS LLC, Detroit, MI (US)

(72) Inventors: Thomas A. Yersak, Ferndale, MI (US); James R. Salvador, Royal Oak, MI (US)

(21) Appl. No.: 16/438,590

(22) Filed: Jun. 12, 2019

(51) Int. Cl. H01M 10/0562; H01M 10/0525; H01M 4/58

(52) U.S. Cl. CPC H01M 10/0562; H01M 4/5815; H01M 10/0525

(57) ABSTRACT

A green solid-state battery layer includes a spread of particles and a protective sacrificial binder that covers and binds together the spread of particles. The spread of particles includes sulfide-based solid-state electrolyte particles and the protective sacrificial binder is removable through thermal decomposition or volatilization at a temperature of 400° C. or lower. A method of forming a solid-state battery layer is also disclosed in which a green solid-state battery layer is formed, a protective sacrificial binder that covers and binds a spread of particles of the green solid-state battery layer is removed, and the resultant intermediate battery layer is consolidated.

### INTRODUCTION

An all-solid-state battery includes an ion-conducting solid-state electrolyte layer (SSEL) disposed between a negative electrode and a positive electrode. Examples of such batteries include solid-state lithium ion batteries and solid-state sodium ion batteries. These types of batteries are being developed as a viable alternative to lithium ion batteries that utilize a liquid electrolyte, which is typically comprised of a lithium salt dissolved in a non-aqueous solvent, to facilitate lithium ion mobility. All-solid-state batteries have the potential to achieve higher energy densities and to operate within a wider temperature window than current lithium ion batteries that utilize a liquid electrolyte. Eliminating the need to use a liquid electrolyte is also considered to be a benefit. Currently, sulfide-based solid-state electrolyte materials are at the forefront of commercialization efforts. Not only are sulfide-based solid-state electrolyte material particles consolidated to produce a solid-state electrolyte layer, but they may also be dispersed within the positive and/or negative electrode layers and intermingled with the positive and negative electrode active materials to establish the phase boundaries needed to effectively transfer ions (e.g., lithium or sodium ions) into and out of the electrode layers.

Sulfide-based solid-state electrolyte materials are inorganic solids that have an integrated molecular network of one or more glass formers and one or more glass modifiers plus an optional glass dopant. At least one of the glass formers or the glass modifiers, or both, includes sulfur, and at least one of the glass modifiers and/or glass dopants includes lithium/sodium to impart lithium/sodium ion conductivity. A sulfide-based solid-state electrolyte material may be an amorphous solid, in which case its integrated molecular network is disordered, or the electrolyte material may be a glass-ceramic solid, in which case its integrated molecular network includes amorphous glassy regions of network disorder and crystalline regions of network order or chain alignment. Numerous sulfide-based solid-state electrolyte material compositions may exhibit the lithium/sodium ionic conductivity as well as the thermal and electrochemical stability demanded for battery applications. However, sulfide-based solid-state electrolyte materials tend to have poor moisture stability. Indeed, moisture from the ambient environment, even at a relatively low relative humidity, tends to hydrolyze surface regions of the sulfide-based solid-state electrolyte materials where sulfur is present to release hydrogen sulfide.

To protect the materials against hydrolysis, sulfide-based solid-state electrolyte materials are typically processed on a lab-scale in an environment known as an “inert glovebox.” An inert glovebox is a dry, inert (e.g., argon) environment where the dew point is ≤−90° C. (equivalent to 0.0004% relative humidity at 70° F.). The atmosphere in an inert glovebox is significantly drier than a standard “dry room”—in which lithium ion batteries that utilize a liquid electrolyte are normally assembled—where the dew point is ≤−40° C. (equivalent to 0.5% relative humidity at 70° F.). The costs required to build, operate, and maintain a standard dry room are not insignificant, and therefore contribute to the overall cost of a manufactured battery pack on a dollar-per-kWh basis. These costs will only escalate, possibly to the point of economic infeasibility, if an inert glovebox or even an environment that is dehumidified to some level between an inert glovebox and a standard dry room (e.g., a dew point of ≤70° C. which is equivalent to 0.005% relative humidity at 70° F.) is required on a commercial scale to process, handle, and assemble solid-state electrolyte layers and/or battery electrode layers that include sulfide-based solid-state electrolyte material particles. As such, there is a need to improve the moisture sensitivity of sulfide-based solid-state electrolyte materials so that those materials can be processed at least in a standard dry room of the type already being used for the assembly of current lithium ion batteries.

### SUMMARY OF THE DISCLOSURE

A green solid-state battery layer according to one embodiment of the present disclosure includes a spread of particles and a protective sacrificial binder. The spread of particles comprises sulfide-based solid-state electrolyte particles, and the protective sacrificial binder covers and binds together the spread of particles. The protective sacrificial binder is removable through thermal decomposition or volatilization at a temperature of 400° C. or lower. In one implementation, the spread of particles includes only the sulfide-based solid-state electrolyte particles. In another implementation, the spread of particles includes sulfide-based solid-state electrolyte particles and active electrode material particles.

The protective sacrificial binder may assume any of several variations. In one implementation, the protective sacrificial binder is an interconnected web dispersed through and around the particles of the spread of particles such that each of the particles is coated with an exterior layer of the protective sacrificial binder. In another implementation, the protective sacrificial binder partially encapsulates an exterior of the spread of particles to enclose the particles against a substrate. In still another implementation, the protective sacrificial binder fully encapsulates an exterior of the spread of particles. Moreover, the green solid-state battery layer may be supported on a plastic substrate or a metallic current collector foil.

The sulfide-based solid-state electrolyte particles included in the spread of particles may be further defined. For example, the sulfide-based solid-state electrolyte particles may be comprised of a sulfide-based solid-state electrolyte material that includes an integrated molecular network of one or more glass formers and one or more glass modifiers. The one or more glass formers may comprise at least one of P₂S₅, SiS₂, GeS₂, B₂S₃, Sb₂S₅, P₂O₅, SiO₂, GeO₂, or a combination of any two or more of such glass formers, and the one or more glass modifiers may comprise (i) at least one of Li₂S, LiO₂, or a combination thereof, or (ii) at least one of Na₂S, NaO₂, or a combination thereof. Additionally, the sulfide-based solid-state electrolyte material may further comprise a glass dopant comprising (i) at least one of LiI, LiCl, LiBr, Li₃PO₄, Li₂SiO₃, or a combination of any two or more of such glass dopants, or (ii) least one of NaI, NaCl, NaBr, Na₃PO₄, Na₂SiO₃, or a combination of any two or more of such glass dopants. The sulfide-based solid-state electrolyte material may be a glass-ceramic that includes at least one precipitated crystalline phase.

A green solid-state battery layer according to another embodiment of the present disclosure includes a spread of particles and a protective sacrificial binder. The spread of particles comprises sulfide-based solid-state electrolyte particles, which, in turn, are comprised of a sulfide-based solid-state electrolyte material that includes an integrated molecular network of one or more glass formers and one or more glass modifiers. The one or more glass formers comprises at least one of P₂S₅, SiS₂, GeS₂, B₂S₃, P₂O₅, SiO₂, GeO₂, or a combination of any two or more of such glass formers, and the one or more glass modifiers comprises (i) at least one of Li₂S, LiO₂, or a combination thereof, or (ii) at least one of Na₂S, NaO₂, or a combination thereof. The protective sacrificial binder covers and binds together the spread of particles and is composed of poly(propylene carbonate).

In one implementation, the spread of particles includes only the sulfide-based solid-state electrolyte particles. In another implementation, the spread of particles includes sulfide-based solid-state electrolyte particles and active electrode material particles. The protective sacrificial binder that covers and binds together the spread of particles may be an interconnected web dispersed through and around the particles of the spread of particles such that each of the particles is coated with an exterior layer of the protective sacrificial binder. The protective sacrificial binder may also partially encapsulate an exterior of the spread of particles to enclose the particles against a substrate. The substrate may be a plastic substrate or a metallic current collector foil. Still further, the protective sacrificial layer may fully encapsulate an exterior of the spread of particles.

A method of forming a consolidated battery layer is also disclosed. The method may include several steps. In one step, a green solid-state battery layer is formed. The green solid-state battery layer comprises a spread of particles and a protective sacrificial binder that covers and binds together the spread of particles. The spread of particles comprises sulfide-based solid-state electrolyte particles, and the protective sacrificial binder is removable at a temperature of 400° C. or lower. In another step of the method, the protective sacrificial binder is removed from the spread of particles by thermally decomposing or volatilizing the protective sacrificial binder to form an intermediate battery layer. In still another step of the method, the intermediate battery layer is consolidated after removal of the protective sacrificial binder to decrease a porosity of the spread of particles and to thereby form a consolidated battery layer having a porosity of 20% or less. In one implementation of the aforementioned method, the intermediate battery layer is consolidated by pressing the layer at an elevated temperature to merge the sulfide-based solid-state electrolyte particles into a unitary structure that lacks particle boundaries.

### BRIEF DESCRIPTION OF THE DRAWINGS

FIG. 1 is a cross-sectional view of a substrate-supported green solid-state battery layer that includes sulfide-based solid-state electrolyte particles bound together and covered by a protective sacrificial binder according to one embodiment of the present disclosure;

FIG. 2 is a cross-sectional view of a free-standing green solid-state battery layer that includes sulfide-based solid-state electrolyte particles bound together and covered by a protective sacrificial binder according to another embodiment of the present disclosure;

FIG. 3 is a cross-sectional view of a substrate-supported green solid-state battery layer that includes sulfide-based solid-state electrolyte particles bound together and covered by a protective sacrificial binder according to yet another embodiment of the present disclosure;

FIG. 4 is a cross-sectional view of a free-standing green solid-state battery layer that includes sulfide-based solid-state electrolyte particles bound together and covered by a protective sacrificial binder according to still another embodiment of the present disclosure;

FIG. 5 illustrates the thermal decomposition mechanisms of one particular type of protective sacrificial binder, poly(propylene carbonate), that transpires when the green solid-state battery layer is heated according to one embodiment of the present disclosure;

FIG. 6 is a plot of hydrogen sulfide (H₂S) concentration in parts per million (ppm) versus time in minutes for three samples of ball-milled (Li₂S)₅₇(SiS₂)₃₅(P₂S₅)₇ solid-state electrolyte particles that were placed in a 300 L glovebox filled with ambient air having a dew point of 3° C. (30% relative humidity), wherein a first sample had no protective sacrificial binder applied and acted as a control, a second sample had a 10 wt % PPC protective sacrificial binder applied, and a third sample had a 20 wt % PPC protective sacrificial polymer applied;

FIG. 7 is an idealized generic depiction of an all-solid-state lithium/sodium ion battery unit cell that includes a negative electrode layer, a positive electrode layer, and a solid-state electrolyte layer disposed between the negative and positive electrode layers according to one embodiment of the invention; and

FIG. 8 is an idealized generic depiction of a lithium/sodium metal battery unit cell that includes a negative electrode layer, a positive electrode layer, and a solid-state electrolyte layer disposed between the negative and positive electrode layers according to one embodiment of the invention in which the negative electrode layer is a layer of lithium/sodium metal.

### DETAILED DESCRIPTION

The present disclosure is directed to green solid-state battery layers that include sulfide-based solid-state electrolyte particles bound together and covered by a protective sacrificial binder. The term “green” as used herein refers to a layer that has not yet been consolidated to its final working porosity of 20% or less. The green solid-state battery layer includes individual particles of a sulfide-based solid-state electrolyte material that are bound together by the protective sacrificial binder either alone or in combination with other particles such as active electrode material particles and/or electrically conductive diluent particles. In this state, the green solid-state battery layer has a porosity that is greater than its final working porosity and, in many instances, ranges anywhere from 20% to 30%. In addition to binding the particles together into a handleable layer, the protective sacrificial binder also shields the sulfide-based solid-state electrolyte particles from moisture contained in the surrounding ambient environment and, thus, obstructs the hydrolysis of the electrolyte particles. To that end, the green solid-state battery layer can be handled and processed in a dry room or even possibly in an open-air environment for a reasonable period of time without being aggressively hydrolytically attacked.

Referring now to FIG. 1, a green solid-state battery layer 10 is shown that includes a spread 12 of particles 14 in sheet form. Some or all of the particles 14 may be sulfide-based solid-state electrolyte particles 16. The sulfide-based solid-state electrolyte particles 16 are bound together and covered by a protective sacrificial binder 18. Here, in this embodiment, the battery layer 10 includes only sulfide-based solid-state electrolyte particles 16, and the protective sacrificial binder 18 is an interconnected web dispersed through and around the electrolyte particles 16 such that each of the electrolyte particles 16 is coated with an exterior layer 20 of the binder 18. The exterior layers 20 of the protective sacrificial binder 14 that coat the individual electrolyte particles 16 function, in the aggregate, to cover and interconnect the particles 16 and protect them from the surrounding ambient environment. The battery layer 10 has a thickness 101 that preferably ranges from 10 μm to 200 μm, and the individual electrolyte particles 16 have particles sizes defined by their largest size dimension (not including the exterior layers 20 of the protective sacrificial binder 18) that preferably range from 0.1 μm to 20 μm. A distribution of particles sizes within this preferred range is generally desired in order to attain efficient packing of the spread 12 of particles 14. Also, as indicated above, the lithium ion battery layer 10 may have a porosity that ranges anywhere from 20% to 30%.

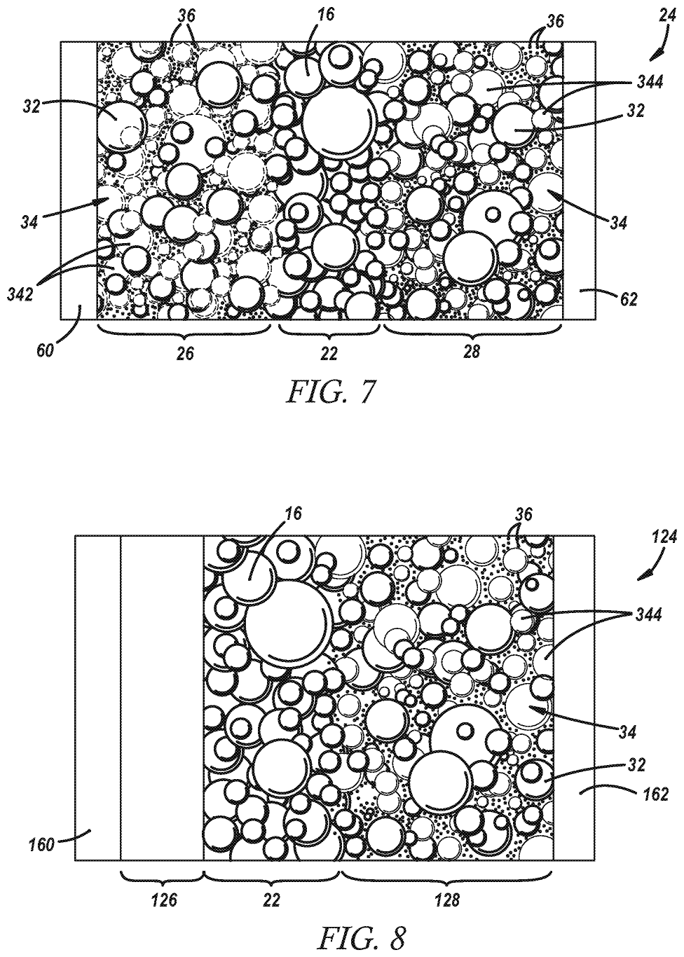

The green solid-state battery layer 10 shown here in FIG. 1 may have a variety of battery use applications. Because the particles 14 included in the battery layer 10 include only sulfide-based solid-state electrolyte particles 16, the battery layer 10 may be consolidated at a later time after removal of the protective sacrificial binder 18, which will be described in further detail below, to form a battery electrolyte layer 22 for an all-solid-state lithium/sodium ion battery unit cell 24, as shown in FIG. 7, or a lithium/sodium metal battery unit cell 124, as shown in FIG. 8. The term “lithium/sodium ion battery unit cell” is used here as a short-form reference to a lithium ion battery unit cell and a sodium ion battery unit cell. The two cells and, thus, batteries comprised of one or more of the two types of cells, are similar in that they both reversibly pass ions between the negative and positive electrode layers with the aid of an electrolyte. A lithium ion battery unit cell transfers lithium ions between the electrode layers and a sodium ion battery unit cell transfers sodium ions between the electrode layers. The terms “lithium/sodium metal battery unit cell” is used as a similar short-form reference to a lithium metal battery unit cell and a sodium metal battery unit cell.

In each of the lithium/sodium ion battery unit cell 24 and the lithium/sodium metal battery unit cell 124, the battery electrolyte layer 22 is disposed between a negative electrode layer 26, 126 and a positive electrode layer 28, 128. In this way, the battery electrolyte layer 22 functions as a separator that physically separates and electrically insulates the electrode layers 26, 126, 28, 128 from each other while at the same time providing an ionically-conductive medium for lithium ions or sodium ions to travel from the negative electrode 26, 126 to the positive electrode 28, 128 during cell discharge and in the reverse direction during cell charging. The battery electrolyte layer 22 may also be used as a replacement for a microporous polymer separator originally included in the lithium/sodium metal battery unit cell 124 or a lithium ion battery unit cell that contains a liquid electrolyte, or a replacement for the original electrolyte layer of the all-solid-state lithium/sodium ion battery unit cell 24. Of course, in other embodiments, some of which are described below, the green solid-state battery layer 10 may include one or more additional types of particles in combination with the sulfide-based solid-state electrolyte particles 16.

The sulfide-based solid-state electrolyte particles 16 are comprised of a sulfide-based solid-state electrolyte material. The solid-state electrolyte material is an inorganic solid having an integrated molecular network of one or more glass formers and one or more glass modifiers plus an optional glass dopant. The glass former(s) establish the primary inorganic molecular network of the electrolyte material, and the glass modifiers and glass dopants are substituted within the primary network to influence the properties of the electrolyte material. To be considered “sulfide-based,” at least one of the glass formers or the glass modifiers, or both, includes sulfur. Moreover, to render the electrolyte material lithium-ion-conductive, at least one of the glass modifiers and/or the glass dopants, if present, includes lithium. A wide variety of glass formers, glass modifiers, and glass dopants may be employed to compose the sulfide-based solid-state electrolyte material that constitutes the electrolyte particles 16. For example, the one or more glass formers may be at least one of P₂S₅, SiS₂, GeS₂, B₂S₃, Sb₂S₅, P₂O₅, SiO₂, GeO₂, or a combination of any two or more of such glass formers, the one or more glass modifiers may be at least one of Li₂S, LiO₂, or a combination thereof, and the one or more optional glass dopants may include at least one of LiI, LiCl, LiBr, Li₃PO₄, Li₂SiO₃, or a combination of any two or more of such glass dopants. To render the electrolyte material sodium-ion-conductive, at least one of the glass modifiers and/or the glass dopants, if present, includes sodium. For instance, while the glass formers noted above may remain the same, the one or more glass modifiers may be at least one of Na₂S, Na₂O, or a combination thereof, and the one or more optional glass dopants may include at least one of NaI, NaCl, NaBr, Na₃PO₄, Na₂SiO₃, or a combination of any two or more of such glass dopants, The electrolyte material of the particles 16 may be an amorphous glassy material or a glass-ceramic material depending on whether some portion of the material is crystallized.

Several exemplary sulfide-based solid-state electrolyte materials are particularly good candidates for the sulfide-based solid-state electrolyte particles 16 of the battery layer 10. These electrolyte materials include lithium phosphorus (oxy)sulfide, sodium phosphorus (oxy)sulfide, lithium boron (oxy)sulfide, sodium boron (oxy)sulfide, lithium boron phosphorous oxysulfide, sodium boron phosphorous oxysulfide, lithium silicon (oxy)sulfide, sodium silicon (oxy)sulfide, lithium germanium (oxy)sulfide, sodium germanium (oxy)sulfide, lithium arsenic (oxy)sulfide, sodium arsenic (oxy)sulfide, lithium selenium (oxy)sulfide, sodium selenium (oxy)sulfide, lithium antimony (oxy)sulfide, and sodium antimony (oxy)sulfide. The term “(oxy)sulfide” as used above refers to both the oxygen-free sulfide and the oxygen-containing oxysulfide materials. For instance, the lithium phosphorus (oxy)sulfide composition encompasses materials such as P₂S₅—Li₂S, P₂S₅—LiO₂, and/or P₂O₅—Li₂S. The solid-state electrolyte material may thus be an oxide-forming system with a sulfide co-former (e.g., Li₂O—P₂O₅—P₂S₅) or a sulfide-forming system with an oxide co-former (e.g., Li₂S—P₂S₅—P₂O₅). In the electrolyte materials listed above as well as others not listed, the glass formers are usually present in 20 mol % to 60 mol % while the glass modifiers are usually present in 40 mol % to 80 mol % and the glass dopants, if included, are usually present at up to 40 mol %. The electrolyte material may also comprise a precipitated sulfide crystal phase depending on the chemistry of the electrolyte material including, but not limited to, Li₇P₃S_{11-X}O_{X} (0≤X≤2.5), Li₁₀P₂MS₁₂ (M=Ge, Sn, Si), Li₃PS₄, Li₇P₂S₈I, and Li₆PS₅X (X═Cl, Br, I, BH₄).

The protective sacrificial binder 18 is a removable and water-resistant organic polymer. The polymer chosen is preferably thermally decomposable and/or volatilizable at a temperature of 400° C. or below. Polymers that decompose at 400° C. or below are satisfactory since they allow the protective sacrificial binder 18 that covers and protects the sulfide-based solid-state electrolyte particles 16 to be removed as decomposition products from the battery layer 10 before the battery layer 10 is consolidated to its final working porosity—the consolidation may occur just before or while the layer 10 is assembled with its other companion battery layers—without unintentionally devitrifying the electrolyte materials of the particles 16 or otherwise thermally affecting the battery layer 10 in an unintended manner. The thermal decomposition of the polymer also cannot leave behind significant carbon residues since heating the battery layer 10 to burn off the residues is generally not practical without damaging the battery layer 10 and its contents. Carbon residues are also electrically conductive, which may be deleterious to the function of an electrolyte layer. A particularly preferred binder polymer that is thermally decomposable and, as such, may be used to form the protective sacrificial binder 18, is poly(propylene carbonate). PPC thermally decomposes into liquids and gases, as explained below, and has a relatively high vapor pressure, meaning it can be decomposed rather quickly through the application of heat and/or a decrease in pressure of the surrounding environment. The chemical formula for poly(propylene carbonate) (sometimes referred to as “PPC”) is shown below as formula (I).

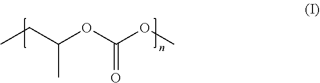

Polymers that volatilize at 400° C. or below are also satisfactory for use as the protective sacrificial binder 18 since they allow the binder 18 that covers and protects the sulfide-based solid-state electrolyte particles 16 to be removed from the battery layer 10 through evaporation before the battery layer 10 is consolidated to its final working porosity. Such removal of the polymer, as before, can be occur without unintentionally devitrifying the electrolyte materials of the particles 16 or otherwise thermally affecting the battery layer 10 in an unintended manner. Volatilizing the binder polymer also should not leave behind significant carbon residues, although residual carbon materials are more of a concern with thermal decomposition as opposed to evaporation. One particular group of volatilizable binder polymers that may be employed to form the protective sacrificial binder 18 include thermoplastic resins such as an acrylic resin, ethyl cellulose, hydroxypropyl cellulose, polyethylene, oxidized polyethylene, cellulose acetate, nylon, a polystyrene, polybutylene, and polyethylene glycol. Waxes such as paraffin wax and oils such as mineral oil, vegetable oil, and paraffin oil may also be used.

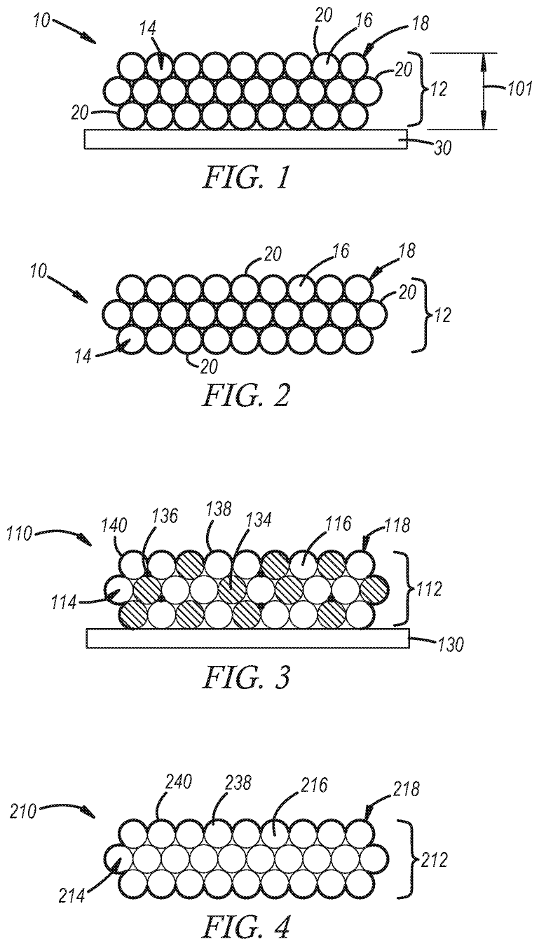

The green solid-state battery layer 10 may be supported on a substrate 30, as shown in FIG. 1, or it may be a free-standing layer, as shown in FIG. 2. If supported on the substrate 30, the substrate 30 may be plastic layer, such as a polyimide (e.g., poly(4,4′-oxydiphenylene-pyromellitimide, available under the tradename KAPTON) or a polyolefin (e.g., polyethylene or polypropylene), and it may be about 10 μm to 40 μm thick. This type of substrate allows the battery layer 10 to be handled and then transferred to another battery material layer. For example, and referring back to FIG. 7, the battery layer 10 may be manufactured as explained below onto a plastic substrate and then subsequently transferred from the substrate onto another battery layer from which either the negative electrode layer 26 or the positive electrode layer 28 of the all-solid-state lithium/sodium ion battery unit cell 24 is derived. The battery layer 10 as supported would eventually be consolidated into the battery electrolyte layer 22 discussed above while the other battery layer would be consolidated into either the negative electrode layer 26 or the positive electrode layer 28 at the same time. As another example, and referring back to FIG. 8, the battery layer 10 may be transferred from the plastic substrate onto the negative electrode layer 126, which is a layer of lithium/sodium metal, or onto a layer from which the positive electrode 128 of the lithium metal battery unit cell 124 is derived, followed by consolidation. A free-standing battery layer 10, on the other hand, could be consolidated alone or together with another battery layer and provides the additional flexibility of being able to be incorporated into an existing all-solid-state lithium/sodium ion battery unit cell or a lithium/sodium metal battery unit cell (all-solid-state or one that includes a liquid electrolyte) as a replacement for the original separator layer.

The battery layer of the negative electrode layer 26 or the positive electrode layer 28 of the all-solid-state lithium/sodium ion battery unit cell 24 onto which the green solid-state battery layer 10 may be transferred includes a mixture of solid-state electrolyte particles 32 and active electrode material particles 34, as depicted in FIG. 7. The nonconsolidated battery layer may also include electrically-conductive diluent particles 36 such as those of carbon black. The solid-state electrolyte particles 32 may be sulfide-based solid-state electrolyte particles similar to the particles 16 described above or they may be some other type of solid-state electrolyte particles. The composition of the active electrode material particles 34 depends on whether the battery layer is intended to be consolidated into the negative electrode layer 26 or the positive electrode layer 28 of the lithium/sodium ion battery unit cell 24. Indeed, a negative electrode active material stores lithium/sodium at a higher energy state (or a lower electrochemical potential relative to a reference electrode) than a positive electrode active material.

For instance, if the battery layer is constituted to be the negative electrode layer 26 of an all-solid-state lithium ion battery unit cell, the active electrode material particles 34 (identified here as particles 342) may be composed negative electrode active material including Li₄Ti₅O₁₂, a metal oxide such as vanadium oxide (V₂O₅), or a carbonaceous material such as graphite, graphene, or carbon nanotubes. If, on the other hand, the battery layer is constituted to be the positive electrode layer 28 of an all-solid-state lithium ion battery unit cell, the active electrode particles 34 (identified here as particles 344) may be composed of a positive electrode active material including rock salt layered oxides such as LiCoO₂, LiNi_{(X)}Mn_{(Y)}Co_{(1-X-Y)}O₂, or LiN_{(X)}Mn_{(1-X)}O₂, a spinel material such as LiMn₂O₄ or LiNi_{X}Mn_{1.5}O₄, or a polycation phosphate (e.g., LiV₂(PO₄)₃) or a polycation silicate (e.g., LiFeSiO₄). As another example, if the battery layer is constituted to be the negative electrode layer 26 of an all-solid-state sodium ion battery unit cell, the active electrode material particles 34 (342) may be composed of a negative electrode active material including alloys containing Si and Sb, hard carbons, expanded graphite, or a composite of expanded graphite and reduced graphene oxide. And, if the battery layer is constituted to be the positive electrode layer 28 of an all-solid-state sodium ion battery unit cell, the active electrode particles 34 (344) may be composed of a positive electrode active material including a layered oxide such as Na_{X}T_{M}O₂ (T_{M}=1 or more transition metals such as Ti, V, Cr, Mn, Fe, Co, or Ni) or a conversion material such as S or FeS₂, and if the battery layer is constituted to be the positive electrode layer 28.

As for the lithium/sodium metal battery 124 depicted in FIG. 8, those types of battery unit cells have the same layers and construction as the all-solid-state battery unit cell 24 described above, whether a lithium ion battery unit cell or a sodium ion battery unit cell, except that the negative electrode layer 126 is a layer of lithium metal or sodium metal, which is typically about 1 μm to 100 μm thick, and the battery layer 22 may or may not be infiltrated with a liquid electrolyte. The positive electrode layer 128 of this unit cell 124 has the same construction as the positive electrode 28 of the all-solid-state lithium/sodium ion battery unit cell 24 shown in FIG. 7.

The green solid-state battery layer 10 may be formed from a slurry composition. To prepare the slurry composition, an amount of the binder polymer (e.g., PPC) may be dissolved in an organic solvent that is immiscible in water to form a solution. A preferred solvent is methoxybenzene (also known as “anisole”). After the binder polymer is dissolved, an amount of the sulfide-based solid-state electrolyte particles 16 are added to the solution to form the slurry composition. The sulfide-based solid-state electrolyte particles 16 may be prepared according to conventional practices including, for example, melting the oxide- and/or sulfide-based constituent formers, modifiers, and optional dopants in a furnace to form a melt of the sulfide-based solid-state electrolyte material and then quenching the melt rapidly through its supercooled liquid state to below its glass transition temperature into a flattened ribbon of bulk amorphous solid-state electrolyte material. The bulk ribbon of the solid-state electrolyte material may be annealed to remove internal stresses and, if desired, heated to induce partial crystallization if a glass-ceramic electrolyte material is desired. The bulk solid-state electrolyte material ribbon may then be ball milled to form the sulfide-based solid-state electrolyte particles 16. Various other techniques may be employed to form the sulfide-based solid-state electrolyte particles 12 including the processes described in commonly-owned U.S. Pub. No. 2018/0294517.

The slurry composition, once prepared, is deposited into a thin-film precursor battery layer approximately 10 μm to 200 μm thick. As for the proportions of the binder polymer and the sulfide-based solid-state electrolyte particles 16 included in the slurry, the amount of the binder polymer may range from 1 part to 50 parts by weight, or more narrowly from 5 parts to 40 parts by weight or even more narrowly from 10 parts to 30 parts by weight, per 100 parts by weight of the binder polymer and the electrolyte particles 16. The slurry may be deposited onto the substrate 30 by tape casting or any other suitable thin-film deposition process. Tape casting involves applying the slurry composition to a flat surface of the substrate 30 and spreading the applied slurry to the desired thickness and width using a doctor blade. In a typical application of tape casting, the substrate 30 is unwound from a reel and pulled along a support table through a slurry box that houses the slurry composition. The doctor blade is affixed to the exit wall of the slurry box so that the substrate 30 exits the slurry box with the precursor battery layer deposited on its upward-facing and uncovered surface. The particular form and composition of the substrate 30 depends on whether the battery layer 10 is intended to be substrate-supported (FIG. 1) or free-standing (FIG. 2).

After being deposited, the precursor battery layer is dried to remove the organic solvent (e.g., the methoxybenzene), thereby producing the green solid-state battery layer 10, which, in this particular embodiment, is constructed and formulated to be the battery electrolyte layer 22 depicted in FIGS. 7 and 8. The drying of the precursor battery layer 10 may occur unassisted in static air at room temperature (i.e., 25° C.) or, in an alternate implementation, the evaporation rate of the solvent may be accelerated with the aid of air blowers, a subatmospheric environment, and/or moderate heat provided, for example, by a series of heat lamps through which the precursor battery layer is progressed. During drying, the dissolved binder polymer precipitates, polymerizes, and eventually coats the sulfide-based solid-state electrolyte particles 16 to provide the interconnected exterior layers 20 of the protective sacrificial binder 18 that cover the individual particles 16. The substrate 30 with the deposited battery layer 10 may then be rewound onto another reel or cut into smaller segments sized for a particular lithium/sodium ion battery application. The same process may be used to form the green solid-state battery layer 10 in free-standing form except that, following drying, the battery layer 10 is delaminated from the substrate 30, which in that scenario may be a plastic substrate. The delamination of the battery layer 10 and the substrate 30 may be facilitated by additional heating to separate the two layers 10, 30.

The battery layer 10 described in the present disclosure is subject to some variability beyond what is shown specifically in FIGS. 1-2 without detracting from the spirit and objectives of the present disclosure. For instance, FIGS. 3-4 depict alternate embodiments of the green solid-state battery layer, which in these figures is identified by reference numerals 110, 210. Indeed, in the following discussion of the alternate battery layer embodiments, reference numerals that correspond to the reference numerals used in the description of the previous embodiment of FIGS. 1-2 will be used to identify the same or similar elements having the same or similar functionality. To that end, the description of aspects of the previously-described embodiment shown in FIGS. 1-2 apply equally to aspects of the following embodiments that are identified with corresponding reference numerals unless specifically described otherwise. The main difference between the green solid-state battery layers 110, 210 illustrated in FIGS. 3-4 and the battery layer 10 illustrated in FIGS. 1-2 is the configuration of the protective sacrificial binder 118, 218.

Referring now to FIG. 3, the green solid-state battery layer 110 includes a spread 112 of particles 114. The particles 114 include sulfide-based solid-state electrolyte particles 116, as before, either alone or in combination with other particles. If the particles 114 in the battery layer 110 include only the sulfide-based solid-state electrolyte particles 116, the battery layer 110 may be consolidated at a later time after removal of the protective sacrificial binder 118 to form the battery electrolyte layer 22 for the lithium/sodium ion battery unit cell 24 or the lithium/sodium metal battery unit cell 124, as discussed above. If, however, the battery layer 110 includes other particles, such as the active electrode material particles 134 shown here, the battery layer 110 may be consolidated at a later time after removal of the protective sacrificial binder 118 to form either the negative electrode layer 26 or the positive electrode layer 28 of the all-solid-state lithium/sodium ion battery unit cell 24 or the positive electrode layer 128 of the lithium/sodium metal battery unit cell 124 depending, of course, on the composition of the active electrode material particles 134. The active electrode materials particles 134 (if present) may be negative electrode active particles 342 for the negative electrode layer 26 or positive electrode active particles 344 for the positive electrode layer 28, 128 (see FIGS. 7-8). In addition, the particles 114 may also include electrically conductive diluent particles 136, such as carbon black, and may be bound together by a permanent non-sacrificial binder that binds and interconnects the particles 114 as explained below.

The protective sacrificial binder 118 in this embodiment has the same composition and functions as described above and, as such, PPC is a particularly preferred polymer for use as the binder 118 along with any of the other named binder polymers. In this embodiment, however, the sulfide-based solid-state electrolyte particles 116 plus the other particles 134, 136 (if present) are supported on the substrate 130, and the protective sacrificial binder 118 partially encapsulates an exterior 138 of the spread 112 of particles 114—rather than each particle individually as in the previous embodiment—to enclose the particles 114 against the substrate 130. That is, the protective sacrificial binder 118 forms a shell 140 that contacts a portion of the exterior 138 of the spread 112 of particles 114 and covers the particles 114 against the substrate 130 so as to protect the sulfide-based solid-state electrolyte particles 116 from moisture that may be present in the surrounding ambient environment. One reason for deploying the shell 140 of the protective sacrificial binder 114 instead of the previously-described interconnected exterior layers 20 of the individual particles is to minimize the exposure of the active electrode material and electrically conductive diluent particles 134, 136—to the extent those particles 134, 136 are included in the battery layer 110—to the protective sacrificial binder 118.

The green solid-state battery layer 110 of this embodiment may be formed from a slurry composition similar to before. In particular, here, the slurry composition is prepared by adding an amount of the sulfide-based solid-state electrolyte particles 116 and, if desired, an amount of the active electrode material particles 134 and an amount of the electrically conductive diluent particles 136 into a first organic solvent depending on whether the battery layer 110 is intended to be formed into the battery electrolyte layer 22 or either of the negative electrode layer 26 or the positive electrode layer 28 of the lithium/sodium ion battery unit cell 24 or the positive electrode layer 128 of the lithium/sodium metal battery unit cell 124. The first organic solvent may be any solvent that does not dissolve or react with the solid-state electrolyte particles 116, the active electrode particles 134, or the electrically conductive diluent particles 136, if present. Some suitable solvents that may be used here include dodecane, toluene, n-heptane, or mixtures thereof.

Additionally, to help bind the particles 116 (or 116, 134, 136) together, an amount of a permanent non-sacrificial binder may also be added to the slurry composition. The non-sacrificial binder is distinct from and has a different composition than the protective sacrificial binder 118, and also does not thermally decompose or have a boiling point below that of the binder polymer that constitutes the protective sacrificial binder 118. Several examples of permanent non-sacrificial binders include polyvinylidene fluoride (PVdF), an ethylene propylene diene monomer (EPDM) rubber, styrene butadiene rubber (SBR), polyacrylic acid, or mixtures thereof. The permanent non-sacrificial binder generally does not protect the solid-state electrolyte particles 116 from moisture since the binder does not fully cover the particles 114 included in the spread 112 due to the way in which it is processed. In particular, the morphology of the non-sacrificial binder is such that small domains are located between the particles 114 to hold the particles 114 together in an effort to minimize ionic and electrical conductivity losses between the particles 114.

Once prepared, the slurry composition is deposited onto the substrate 130 to obtain a precursor battery layer. The substrate 130 may be a plastic as described above or it may be a metallic current collector foil, typically about 5 μm to 30 μm thick, in the event that the battery layer 110 is constructed to be one of the electrode layers 26, 28 of the lithium/sodium ion battery unit cell 24 or the positive electrode layer 128 of the lithium/sodium metal battery unit cell 124. In that regard, the substrate 130 may be a copper foil 60 (for a negative electrode layer 26) or an aluminum foil 62, 162 (for a positive electrode layer 28, 128), as shown in FIGS. 7-8, or any other suitable metal foil. After being deposited, the precursor battery layer is dried to remove the first organic solvent. At this point, the precursor battery layer is essentially the spread 112 of the particles 114 with the permanent non-sacrificial polymer, if present, helping to hold the particles 114 together. The protective sacrificial binder 118 is then applied over the precursor battery layer to form the shell 140 that contacts and encapsulates a portion of the exterior 138 of the spread 112 of particles 114 to enclose and cover the particles 114 against the substrate 130.

To apply the protective sacrificial binder 118, a solution of the binder polymer is applied over the precursor battery layer by tape casting, dip coating, or some other deposition technique. The solution of the binder polymer may be the binder polymer dissolved in a second organic solvent that does not dissolve the permanent non-sacrificial binder. The second organic solvent is preferably immiscible in water, but that is not necessarily required since the solvent, if it is miscible with water, can simply be dried to an acceptable level. The same solvent disclosed in the previous embodiment (e.g., anisole or methoxybenzene) be used here as the second organic solvent as well. After the solution is applied over the precursor battery layer, the applied and overlying solution is dried to remove the second organic solvent, thereby producing the green solid-state battery layer 110 having the protective sacrificial binder 118 that partially encapsulates and covers the spread 112 of particles 114 against the substrate 130. The applied solution may be dried to remove the second organic solvent by the same procedures mentioned above.

Referring now to FIG. 4, the green solid-state battery layer 210 includes a spread 212 of particles 214 that contains sulfide-based solid-state electrolyte particles 216 either alone or in combination with other particles, as before. Here, the particles 214 of the battery layer 210 are shown as including only sulfide-based solid-state electrolyte particles 216. The battery layer 210 may thus be consolidated at a later time after removal of the protective sacrificial binder 218 to form the battery electrolyte layer 22 for the all-solid-state lithium/sodium ion battery unit cell 24 or the lithium/sodium metal battery unit cell 124. The sulfide-based solid-state electrolyte particles 216 may be bound together by a permanent non-sacrificial binder that interconnects the particles 216 including, for example, polyvinylidene fluoride (PVdF), an ethylene propylene diene monomer (EPDM) rubber, styrene butadiene rubber (SBR), polyacrylic acid, or mixtures thereof. The non-sacrificial binder may be present to hold the electrolyte particles 216 together until the protective sacrificial binder 218 can be applied as well as after the binder 218 has been removed.

The protective sacrificial binder 218 in this embodiment has the same composition and functions as described above and, as such, PPC is a particularly preferred polymer for use as the binder 218 along with any of the other named binder polymers. In this embodiment, the green solid-state battery layer 210 is a free-standing layer; that is, the battery layer 210 is not supported on a substrate. And, as shown, the protective sacrificial binder 218 fully encapsulates an exterior 238 of the spread 212 of particles 214. The protective sacrificial binder 218 thus forms a shell 240 that contacts and covers the entire exterior 238 of the spread 212 of particles 214 to protect the sulfide-based solid-state electrolyte particles 216 (which are the only particles present in this embodiment) from moisture that may be present in the surrounding ambient environment. The green solid-state battery layer 210 may be formed in the same way as the battery layer 110 of the previous embodiment except that the precursor battery layer is delaminated from the substrate prior to applying the protective sacrificial binder 218 to, and fully around, the precursor battery layer from a solution of the binder polymer. In that regard, the precursor battery layer may be dip coated into the solution of the binder polymer or the solution may be tape cast on each side of the precursor battery layer, and the applied and overlying solution may be subsequently dried to remove the solvent from the solution and to leave behind the protective sacrificial binder 218 that fully encapsulates the spread 212 of particles 214.

As noted above, the green solid-state battery layer 10, 110, 210 is eventually further processed into a working consolidated battery layer of the lithium/sodium ion battery unit cell 24 or the lithium/sodium metal battery unit cell 124 such as the battery electrolyte layer 22, the negative electrode layer 26, or the positive electrode layer 28, 128 depending on the types of particles that are included in the spread 12, 112, 212 of particles 14, 114, 214. To complete this transition, the protective sacrificial binder 18, 118, 218 of the battery layer 10, 110, 210 is removed, and the resulting intermediate battery layer, which is basically the spread 12, 112, 114 of particles 14, 114, 214 uncovered along with the optional non-sacrificial binder, is consolidated to reduce the porosity of the intermediate battery layer. All of the processing of the green solid-state battery layer 10, 110, 210 and its conversion to the intermediate battery layer and eventually the consolidated battery layer may be carried out in a standard dry room due to the ability of the protective sacrificial binder 18, 118, 218 to afford some protection to the sulfide-based solid-state electrolyte particles 16, 116, 216 against hydrolysis when the battery layer 10, 110, 210 is exposed to moisture in the ambient environment. The consolidation of the intermediate battery layer may additionally be performed under an inert gas overflow to help shield the layer from moisture after the protective sacrificial binder 18, 118, 218 has been removed.

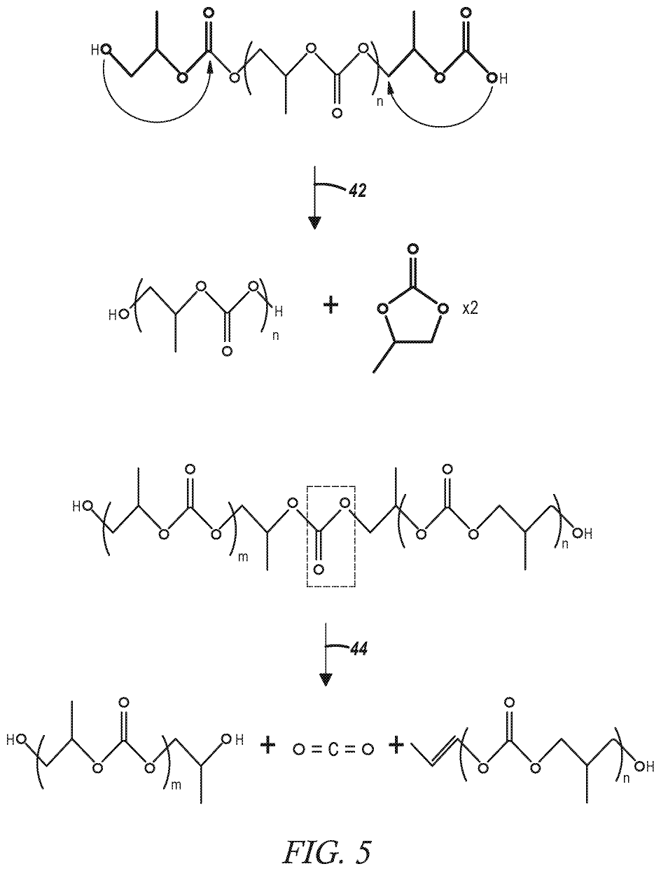

The removal of the protective sacrificial binder 18, 118, 218 involves thermally decomposing or volatilizing the green solid-state battery layer 10, 110, 210 by the application of heat, subjecting the battery layer 10, 110, 210 to a subatmospheric pressure environment, or both. For instance, in the case of PPC, the battery layer 10, 110, 210 may be heated in an oven or some other controlled heating environment to a temperature of 200° C. to 250° C., since the onset of thermal decomposition of PPC is typically between 180° C. and 240° C. The battery layer 10, 110, 210 may be heated alone or in combination with other nonconsolidated battery layers of the lithium/sodium ion battery unit cell 24 or the lithium/sodium metal battery unit cell 124. When heated sufficiently, the PPC decomposes by polymer unzipping and random chain scission, as illustrated in FIG. 5. In the polymer unzipping reaction (arrow 42), thermal energy activates the ends of the polymer chains, causing an alkoxide backbiting reaction (left side) or a carbonate backbiting reaction (right side) depending on how the PPC polymer chains are terminated. In each case, a nucleophile (carboxylate nucleophile in alkoxide backbiting or alcohol end-group nucleophile in carbonate backbiting) attacks an electrophilic carbon atom from the polymer backbone, causing degradation of the polymer to produce cyclic propylene carbonate. In the random chain scission reaction (arrow 44), C═O bonds within the polymer backbone undergo thermally-induced cleavage to produce carbon dioxide and acetone as products. The cyclic propylene carbonate, carbon dioxide, and acetone products that result when PPC is thermally decomposed are easily extracted from the spread 12, 112, 114 of particles 14, 114, 214 and no more than negligible carbon residues are left behind.

The intermediate battery layer may be consolidated into the consolidated battery layer in a variety of ways. The intermediate battery layer may be cold-pressed between opposed and unheated platens to reduce the porosity of the spread 12, 112, 114 of particles 14, 114, 214 while maintaining the particle boundaries of the particles 14, 114, 214. Cold pressing typically results in a porosity between 10% and 20%. As another option, the intermediate battery layer may be hot-pressed between opposed platens that are heated to temperatures often in the range of 100° C. to 350° C. to reduce the porosity of the spread 12, 112, 114 of particles 14, 114, 214 to between 0% and 10%. Similarly, the intermediate lithium ion battery layer may be calendered by feeding the layer between a pair of counterrotating rollers that are heated to temperatures often in the range of 100° C. to 350° C. to achieve the same porosity as hot-pressing. In each of hot-pressing and calendering, the sulfide-based solid-state electrolyte particles 16, 116, 216 included within the layer may be sintered or experience viscoplastic flow, thus resulting in merger of the electrolyte particles 16, 116, 216 into a more unitary structure where the particle boundaries of the electrolyte particles 16, 116, 216 cease to exist. The intermediate battery layer may be consolidated alone or combination with other battery layers such as, for example, when the intermediate battery layer is consolidated together with other battery layers to simultaneously provide the various layers 22, 26, 28, 128 of the lithium/sodium ion battery unit cell 24 or the lithium/sodium metal battery unit cell 124.

### EXAMPLE

An experiment was performed to help demonstrate the moisture-resistant capability of the protective sacrificial binder as described in the present disclosure. Specifically, (LiS)₅₇(SiS₂)₃₅(P₂S₅)₇ ball milled amorphous solid-state electrolyte particles (the subscripts 57, 35, and 7 representing atomic proportions of the sulfide-based solid-state electrolyte material) were added to an anisole solution along with 0 wt %, 10 wt %, and 20 wt % of PPC. The recited weight percents of PPC were based on parts by weight PPC divided by parts by weight (LiS)₅₇(SiS₂)₃₅(P₂S₅)₇ and PPC added in solution. The solutions were then cast to form green solid-state lithium ion battery layers. A sample of each green battery layer was placed in a 300 L glovebox filled with ambient air having a dew point of 3° C. (30% relative humidity). This environment is significantly more humid than a standard dry room, let alone an inert glovebox. The concentration of hydrogen sulfide (H₂S) in ppm was monitored in each of the gloveboxes as a function of time.

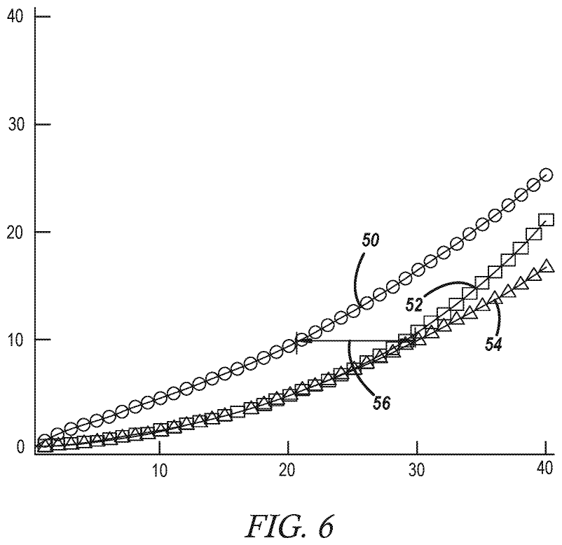

The sample of (LiS)₅₇(SiS₂)₃₅(P₂S₅)₇ particles without any binder was used as the control to evaluate the moisture sensitivity of the other two samples (i.e., the (LiS)₅₇(SiS₂)₃₅(P₂S₅)₇ particles with 10 wt % PPC binder and the (LiS)₅₇(SiS₂)₃₅(P₂S₅)₇ particles with 20 wt % binder). The plots of H₂S concentration versus time are shown in FIG. 6 for each sample. The control (0 wt % PPC binder) is identified by reference numeral 50, the sample having 10 wt % PPC binder is identified by reference numeral 52, and the sample having 20 wt % binder is identified by reference numeral 54. As can be seen, in humid air, the samples with the PPC binder reduced the off-gassing of H₂S by up to 40 minutes and extended the window at which H₂S concentrations were below 10 ppm by nearly 10 minutes (represented by the line identified by reference numeral 56). This data suggests that the green solid-state lithium ion battery layers that include sulfide-based solid-state electrolyte particles as described in the present disclosure may be processed and handled in the drier environment of a standard dry room.

The above description of preferred exemplary embodiments and specific examples are merely descriptive in nature; they are not intended to limit the scope of the claims that follow. Each of the terms used in the appended claims should be given its ordinary and customary meaning unless specifically and unambiguously stated otherwise in the specification.

1. A green solid-state battery layer comprising:
a spread of particles, the spread of particles comprising sulfide-based solid-state electrolyte particles; and
a protective sacrificial binder that covers and binds together the spread of particles, the protective sacrificial binder being removable through thermal decomposition or volatilization at a temperature of 400° C. or lower.

2. The green solid-state battery layer set forth in claim 1, wherein the spread of particles includes only the sulfide-based solid-state electrolyte particles.

3. The green solid-state battery layer set forth in claim 1, wherein the spread of particles includes the sulfide-based solid-state electrolyte particles and active electrode material particles.

4. The green solid-state battery layer set forth in claim 1, wherein the protective sacrificial binder is an interconnected web dispersed through and around the particles of the spread of particles such that each of the particles is coated with an exterior layer of the protective sacrificial binder.

5. The green solid-state battery layer set forth in claim 1, wherein the protective sacrificial binder partially encapsulates an exterior of the spread of particles to enclose the particles against a substrate.

6. The green solid-state battery layer set forth in claim 1, wherein the protective sacrificial binder fully encapsulates an exterior of the spread of particles.

7. The green solid-state battery layer set forth in claim 1, wherein the battery layer is supported on a plastic substrate or a metallic current collector foil.

8. The green solid-state battery layer set forth in claim 1, wherein the sulfide-based solid-state electrolyte particles are comprised of a sulfide-based solid-state electrolyte material that includes an integrated molecular network of one or more glass formers and one or more glass modifiers.

9. The green solid-state battery layer set forth in claim 8, wherein the one or more glass formers comprises at least one of P₂S₅, SiS₂, GeS₂, B₂S₃, Sb₂S₅, P₂O₅, SiO₂, GeO₂, or a combination of any two or more of such glass formers, and the one or more glass modifiers comprises (i) at least one of Li₂S, LiO₂, or a combination thereof, or (ii) at least one of Na₂S, NaO₂, or a combination thereof.

10. The green solid-state battery layer set forth in claim 8, wherein the sulfide-based solid-state electrolyte material further comprises a glass dopant comprising (i) at least one of LiI, LiCl, LiBr, Li₃PO₄, Li₂SiO₃, or a combination of any two or more of such glass dopants, or (ii) least one of NaI, NaCl, NaBr, Na₃PO₄, Na₂SiO₃, or a combination of any two or more of such glass dopants.

11. The green solid-state battery layer set forth in claim 9, wherein the sulfide-based solid-state electrolyte material is a glass-ceramic that includes at least one precipitated crystalline phase.

12. A green solid-state battery layer comprising:
a spread of particles comprising sulfide-based solid-state electrolyte particles, wherein the sulfide-based solid-state electrolyte particles are comprised of a sulfide-based solid-state electrolyte material that includes an integrated molecular network of one or more glass formers and one or more glass modifiers, wherein the one or more glass formers comprises at least one of P₂S₅, SiS₂, GeS₂, B₂S₃, P₂O₅, SiO₂, GeO₂, or a combination of any two or more of such glass formers, and the one or more glass modifiers comprises (i) at least one of Li₂S, LiO₂, or a combination thereof, or (ii) at least one of Na₂S, NaO₂, or a combination thereof; and
a protective sacrificial binder that covers and binds together the spread of particles, wherein the protective sacrificial binder is composed of poly(propylene carbonate).

13. The green solid-state battery layer set forth in claim 12, wherein the spread of particles includes only the sulfide-based solid-state electrolyte particles.

14. The green solid-state battery layer set forth in claim 12, wherein the spread of particles includes the sulfide-based solid-state electrolyte particles and active electrode material particles.

15. The green solid-state battery layer set forth in claim 12, wherein the protective sacrificial binder is an interconnected web dispersed through and around the particles of the spread of particles such that each of the particles is coated with an exterior layer of the protective sacrificial binder.

16. The green solid-state battery layer set forth in claim 12, wherein the protective sacrificial binder partially encapsulates an exterior of the spread of particles to enclose the particles against a substrate, and wherein the substrate is a plastic substrate or a metallic current collector foil.

17. The green solid-state battery layer set forth in claim 12, wherein the protective sacrificial layer fully encapsulates an exterior of the spread of particles.

18. A method of forming a consolidated battery layer, the method comprising:
forming a green solid-state battery layer that comprises a spread of particles and a protective sacrificial binder that covers and binds together the spread of particles, the spread of particles comprising sulfide-based solid-state electrolyte particles, and the protective sacrificial binder being removable at a temperature of 400° C. or lower;
removing the protective sacrificial binder from the spread of particles by thermally decomposing or volatilizing the protective sacrificial binder; and
consolidating the intermediate battery layer after removal of the protective sacrificial binder to decrease a porosity of the spread of particles to thereby form a battery layer having a porosity of 20% or less.

19. The method set forth in claim 18, wherein consolidating the intermediate battery layer comprises pressing the layer at an elevated temperature to merge the sulfide-based solid-state electrolyte particles into a unitary structure that lacks particle boundaries.
